(19) United States
(12) Patent Application Publication
(10) Pub. No.: US 2006/0015822 A1
(43) Pub. Date: Jan. 19, 2006

(54) Method and apparatus for updating a user interface display of a portable communication device

(76) Inventors: Imran Baig, Sunrise, FL (US); Javier E. Landazuri, Sunrise, FL (US); Kivanc Ozseden, Weston, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/891,742

(22) Filed: Jul. 15, 2004

(51) Int. Cl. G06F 17/00; G06F 9/00

(52) U.S. Cl. 715/810; 715/864

(57) ABSTRACT

A menu selection technique (300) dynamically updates a display of a portable communication device, such as a two-way radio. The user enters an alphanumeric entry (306) via a keypad, each entry being added to the contents of an input buffer (308) of the portable communication device. The content of the buffer is matched with available features (310) and the display is updated with a menu selection of the matched available features (312). As user entries are progressively entered, the selection of menu features narrows until the user selects a feature (314) and the feature is launched (316).

### TECHNICAL FIELD

This invention relates in general to portable communication devices and more particularly to the user interface involved in displaying menu selections for such devices.

### BACKGROUND

With the widespread popularity of portable communication devices such as two-way radios, cellular telephones and wireless personal digital assistants, users of the devices are demanding user interfaces that are more intuitive and efficient. The small size of the displays on portable communication devices, however, can cause a user to become disoriented while trying to navigate through the maze of information on a small display. As the number of device features increases, user access to these features can become complicated. In some cases, users have to go through several layers of menu selection using scanning, scrolling and high-lighting canned text to get to the desired feature. This can decrease the likelihood of those features being used just because they are difficult to access. A new user does not want to spend a lot of time having to learn a complex user interface; both new and experienced users want a user interface that efficiently utilizes input actions.

Accordingly, there is a need for an improved portable communication device user interface for menu selection.

### BRIEF DESCRIPTION OF THE DRAWINGS

The features of the present invention, which are believed to be novel, are set forth with particularly in the appended claims. The invention, together with further objects and advantages thereof, may best be understood by reference to the following description, taken in conjunction with the accompanying drawings, in the several figures of which like reference numerals identify like elements, and in which:

FIG. 1 is an illustration in block diagram of a portable communication device incorporating a user interface for menu selection in accordance with the present invention;

FIG. 2 is an example of a portable radio incorporating the user interface of the present invention;

FIG. 3 is a flowchart illustrating a method of updating a display menu of a portable communication device in accordance with the present invention; and

FIG. 4 illustrates examples of user entry progression of keypresses with corresponding menu display updates in accordance with the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

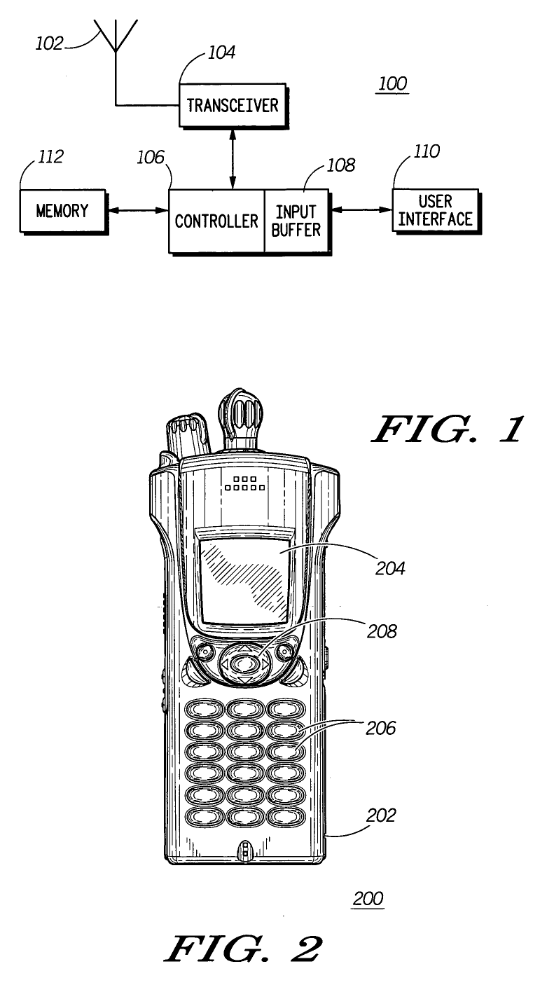

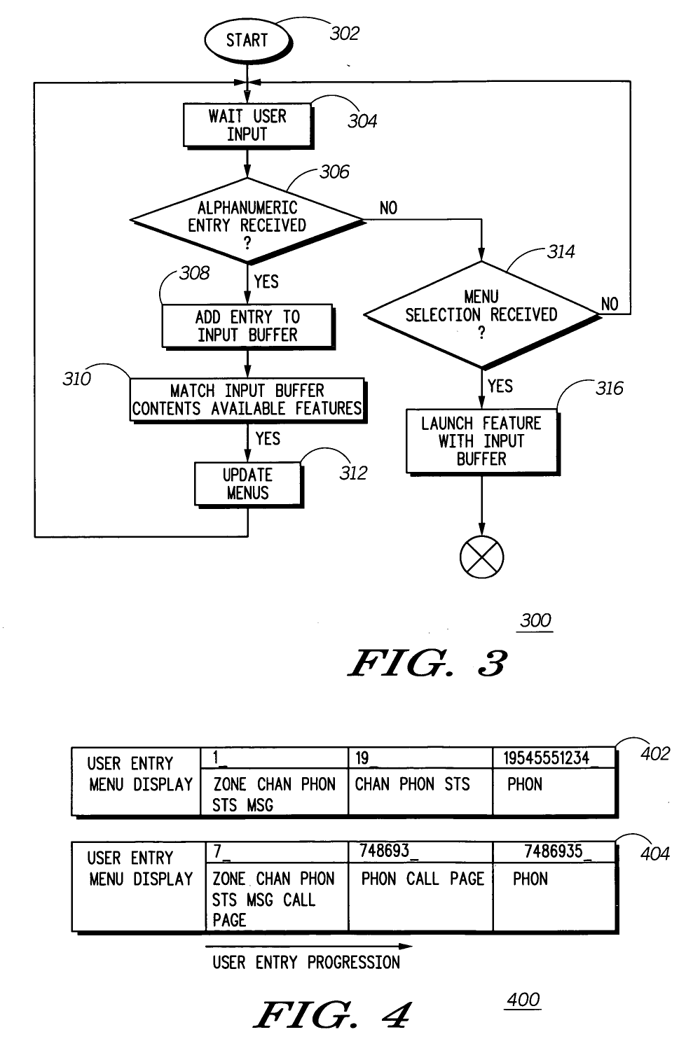

Briefly, in accordance with the present invention there is provided herein an apparatus and technique which facilitate menu selection in a portable communication device. FIGS. 1 and 2, describe a block diagram and physical implementation of a portable communication device with user interface menu selection of the present invention. In FIGS. 3 and 4, a method of updating a user interface display of the portable communication device along with examples of user entries versus displayed menus are provided.

FIG. 1 is a block diagram of a portable communication device 100 incorporating a user interface that facilitates menu selection from a display in accordance with the present invention. The portable communication device 100 provides two-way voice communication and may also include data transfer functions such as internet connectivity, e-mail, and FAX capability. Portable communication device 100 includes an antenna 102, transceiver 104, and controller 106 having input buffer 108, user interface 110 and memory 112. The memory 112 is coupled to the controller 106 and is for permanent and temporary storage of information, data, and software programs necessary for operation of the portable communication device 100. Typically, the user interface 110 includes a microphone, a speaker, a display, and a plurality of input keys.

General transmit and receive operations of the portable communication device 100 are described as follows. On the transmit side, to transmit radio frequency (RF) signals containing transmit data (such as voice, digital information, or control signals) from the portable communication device 100, the user interface 110 directs user input data to a controller 106. Controller 106 formats the transmit data obtained from the user interface 110 and conveys it to a transmitter within transceiver 104 for conversion into RF modulated signals. The transceiver 104 conveys the RF modulated signals to the antenna 102 for transmission. On the receive side, portable communication device 100 detects RF signals containing receive data through the antenna 102 and produces detected RF signals. A receiver within the transceiver 104, coupled to the antenna 102, converts the detected RF signals into electrical baseband signals, demodulates the electrical baseband signals, recovers the receive data and outputs the receive data to the controller 106. The controller 106 formats the data into recognizable voice or data information for the use by user interface 110.

For the purposes of this application, the user interface 110 will focus on the plurality of input keys, data entry to the keys and the ability to facilitate menu generation and selection on the display. In accordance with the present invention, a menu selection technique is stored in the memory 112 and accessed by the controller 106 via input keys in order to control how information is presented to the display.

Portable communication device 100 is preferably a portable radio 200 as shown in FIG. 2. In accordance with the present invention, portable radio 200 incorporates the menu selection technique of the present invention. The menu selection technique of the present invention, provides a smart dialing menu that minimizes the number of keypresses or keystrokes made by a user to display and narrow a menu selection.

The portable radio 200 comprises a portable radio housing 202, a display 204 and a plurality of input keys 206 mounted on the portable radio housing. Referring to FIGS. 1 and 2, in accordance with the present invention, the plurality of input keys 206 are electrically coupled to the controller 106, the controller causing the display 204 to present a sequence of narrowing available menu features in response to progressive alphanumeric entries being entered at the plurality of input keys. Each entry is a single digit, such as the numeral “2” or the letter “b” of some predetermined feature known by the user, for example the digits of a phone number, pager number or zone. In accordance with the present invention, each progressive alphanumeric entry is added to the input buffer 114, the content of the buffer being matched with available features stored in the memory 112. For example, a string of five data entry digits may correspond to three possible menu features. The display 204 is updated with the narrowing available menu features until a selection is made from the menu and the selected feature is launched with the input buffer 114. A select button or single, multi-direction input key 208 may be incorporated on the housing 202 to allow the user to select the desired feature from the menu. Once a feature is selected and launched, no further data entries are required from the user, as the remainder of the data string is tied to the selected feature and also stored in memory 112.

FIG. 3 is a method 300 of updating a user interface display of a portable communication device in accordance with the present invention. Method 300 starts by turning on the radio at step 302, waiting (for some predetermined amount of time) for user input at step 304 and determining whether an alphanumeric entry has been received at step 306. If an entry has been received at step 306, then that entry is added to an input buffer of the controller at step 308. The contents of the input buffer are then matched with available features of the radio at step 310. At step 312, the menu is updated on the display to list the matched entries and further input is awaited at step 304. If another alphanumeric entry is received at step 304, the entry is once again, stored and matched to available features. Thus, the menu update at step 312 will begin to narrow the menu selection of available features. The steps 304-312 are repeated until no more entries are received at step 306. If the user makes a selection from the narrowed menu list at step 314, then the corresponding feature is launched with the input buffer at step 316. If no feature was selected then further input is awaited at step 304.

FIG. 4 illustrates examples 402, 404 of user entry progression of keypresses with corresponding menu display updates. As a first example 402, a data entry of “1” might present a menu selection to the user consisting of a list of the following features: ZONE, CHANNEL, PHONE, STATUS and MESSAGE. The user can either select the desired feature from this menu, via multi-direction input key 208 of FIG. 2, or continue to enter keypresses. For example, a subsequent keypress entry of “9” updates the display with a narrowed menu selection of CHANNEL, PHONE and STATUS. User entry progression continues until the user selects a feature from the menu. In example 402, the following subsequent entries “54555123” are made without any change to the menu selection. The menu selection in example 402 remains static until entry “4” is added to the buffer at which point a final menu selection of PHONE appears on the display.

As a second example, a data entry of “7” might present a menu selection of ZONE, CHANNEL, PHONE, STATUS, MESSAGE, CALL and PAGE. The user can either select the desired feature from this menu, or continue to enter keypresses. In this example, the display remains static during subsequent entries of “4869” until a fifth entry of “3” is entered and the menu selection is narrowed to PHONE, CALL and PAGE. The user can either select the desired feature from this menu, or continue to enter keypresses. In this example, a sixth entry “5” is added to the buffer. With a data string now consisting of “7486935” in the input buffer, the menu selection is narrowed to a single feature: PHONE. Examples 402, 404 demonstrate how the menu selection of a portable communication device is dynamically updated utilizing the menu selection technique of the present invention.

The menu selection technique of the present invention can be summarized by the following steps: receiving an alphanumeric entry, adding the alphanumeric entry to an input buffer of the portable radio, matching the buffer content with available features stored in the portable radio; and updating the display with a menu selection of the matched available features. By repeating the steps of receiving through updating until no further alphanumeric entries are received, the menu selection is narrowed and a selected feature can be launched from the matched available features.

Thus, there has been provided a method and apparatus for presenting a narrowing menu selection on a portable communication device display. The menu selection technique provides many features which significantly aid the user in accessing and entering information through a portable communication device. The menu selection technique of the present invention eliminates the need for any high-lighting of pre-canned text and minimizes scrolling through multiple windows with up/down arrows. Menu items are capable up being updated dynamically as the user dialed entries are received as opposed to menu items being static and not changing. Updating and displaying available features as a data string is entered allows the user to access information faster, which is very important a portable radio environment.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A method of updating a display menu of a portable communication device, comprising the steps of:
making a data entry into the portable communication device;
matching the data entry to available features stored in the communication device;
updating the display menu with the matched available features; and
selecting a feature from the matched available features.

2. The method of claim 1, further comprising the step of repeating the steps of making through updating to progressively narrow the available portable communication device features.

3. The method of claim 1, wherein the step of making a data entry into the portable communication device further comprises the step of adding the data entry into an input buffer.

4. A method of updating a user interface display of a portable communication device, comprising the steps of:
making an entry to an alphanumeric keypad;
determining available portable communication device features for the entry;
displaying a menu of the available portable communication device features; and
repeating the steps of making, determining and displaying to narrow the menu.

5. The method of claim 4, wherein the step of making an entry comprises entering a keystroke by a user.

6. A method of updating a user interface display of a portable radio, comprising the steps of:
receiving an alphanumeric entry;
adding the alphanumeric entry to an input buffer of the portable radio;
matching content of the input buffer with available features of the portable radio;
updating the display with a menu selection of the matched available features;
repeating the steps of receiving through updating until no further alphanumeric entries are received; and
launching a feature from the matched available features.

7. A portable radio comprising:
a portable radio housing;
a display mounted on the portable radio housing;
a controller positioned in the portable radio housing and coupled to the display, the controller having an input buffer;
a memory coupled to the controller; and
a plurality of input keys mounted on the portable radio housing and electrically coupled to the controller, the controller causing the display to present a sequence of narrowing available menu features in response to alphanumeric entries being entered at the plurality of input keys.

8. The portable radio of claim 7, wherein each alphanumeric entry is added to the input buffer and matched with available features stored in the memory, the display being updated with the narrowing available menu features until a selection is made from the menu and the selected feature is launched with the input buffer.
